(19) United States
(12) Patent Application Publication
(10) Pub. No.: US 2015/0060198 A1
(43) Pub. Date: Mar. 5, 2015

(54) IN HOUSE HIGH RISE EVACUATION SYSTEM

(71) Applicant: Edward H. Horn, Hot Springs Village, AR (US)

(72) Inventor: Edward H. Horn, Hot Springs Village, AR (US)

(21) Appl. No.: 14/011,834

(22) Filed: Aug. 28, 2013

(51) Int. Cl. A62B 1/02

(52) U.S. Cl. CPC A62B 1/02
USPC 182/48

(57) ABSTRACT

A system for the evacuation of occupants of a high-rise structure in an emergency, expressly designed to be located within the high-rise structure itself. The system comprises an evacuator which operates over a 10-floor or more distance within a fire inhibiting tubular structure such as a shaft, wherein the evacuator is mounted on a centrally disposed tube mechanically descending from the upper level of the shaft to its lower level with occupants onboard, and wherein this system includes a series of such tubes, such that when occupants on the higher floors descend to the lowest level of the first shaft, they may exit to a second shaft and move to the next unit of the evacuator until they have descended to safety.

The present invention relates, in a general sense, to a system for the evacuation of occupants of a tall structure, such as a skyscraper, and, more particularly, to a system mounted within the structure, as distinguished from an externally mounted system.

### BACKGROUND OF THE INVENTION

1. Field of the Invention

The present invention is an adjunct to the inventor's U.S. Pat. No. 7,766,124, issued Aug. 3, 2010, for a HIGH RISE EVACUATION SYSTEM. That patent teaches a novel system for an emergency procedure capable of assisting the evacuation of a high rise structure in an emergency. That patent teaches the system for evacuating people by external means, and, by that, it is meant that the physical structure is affixed to the exterior surface of the high-rise structure.

In recent years, architects and builders have designed and constructed structures which are essentially sealed from the environment. Windows do not open, and fire escapes are a relic of the past. In such structures, the teachings of the aforementioned Horn patent would require some modification to the structure to provide access to the Horn system, and, while that is not impossible, it requires additional effort, along with assurances that structural integrity remains. It is in order to avoid such additional effort that the present invention was devised.

2. Overview of the Prior Art

Since the advent of multistory buildings, there have been at least two mechanisms which are found consistently, and they are the venerable stairwell and, more recently, the elevator. The taller the structure, the less efficient these two systems become, particularly in a fire.

During the prosecution of Horn '124 patent, some 52 issued United States patents were cited, along with two published applications. All of these items are incorporated herein by reference, and none of them anticipate, or render obvious, the present invention.

### SUMMARY OF THE INVENTION

As is the case with the Horn '124 patent, it is the principle of the present invention to provide a system for the evacuation of persons in danger by virtue of their presence in a tall structure which has sustained damage, which is of such nature as to warrant immediate evacuation from such structure.

It is yet another objective of the present invention to provide a system for the evacuation of a tall, multistory structure, which is sealed against access to the exterior of the structure.

The foregoing objectives, as well as others, will become apparent to those skilled in the art, when the following Detailed Description Of A Preferred Embodiment is read in conjunction with the drawings, wherein:

### DESCRIPTION OF THE DRAWINGS

FIG. 1 is a pictorial representation of a portion of a large stairwell in a multistory structure and showing an evacuation tube situated therein;

FIG. 2 is an enlarged section view of FIG. 1;

FIG. 3 is an enlarged partial sectional of FIG. 2, illustrating some detail of the evacuator mechanism of the present invention;

FIG. 4 is an enlarged side elevation of the evacuator as it is positioned at rest on a central pole ready to see evacuees;

FIG. 5 is a pictorial representation of a portion of the counter balance system used to return the evacuator, or platform, to its original position;

FIG. 6 is a pictorial representation of a portion of the manual braking system of the present system, shown in its relaxed, or disengaged, position;

FIG. 7 is a pictorial representation of the brake handle and associated braking system, with the braking system in the FIG. 6 attitude;

FIG. 8 is a pictorial representation of the braking system of FIG. 6, shown in its clamping, or braking, attitude;

FIG. 9 is a pictorial representation of the brake holding pedal which is part of the system braking system;

FIG. 10 is a pictorial representation of a shock absorber positioned at the low point of travel of the evacuator unit at the arrival of that device;

FIG. 11 depicts a door which opens into the tubular structure housing the evacuator, also showing the door closer at the top and operating mechanism for the stop arm at the bottom;

FIG. 12 is a partial sectional view showing the base of a typical floor defining a passage and the stop arm mechanism for that floor;

FIG. 13 is a side elevation, fragmented and showing the stop arm mechanism beneath the door of the typical floor;

FIG. 14 is a view illustrating the evacuator arriving at the floor, as depicted in FIG. 12, and showing the stop arm mechanism;

FIG. 15 is a depiction similar to that of FIG. 13, ready to be moved when the door is opened; and,

FIGS. 16 and 17 show the operation of the stop arm mechanism prior to and as the carriage arrives at a floor.

### DETAILED DESCRIPTION OF A PREFERRED EMBODIMENT

It is necessary to understand the environment in which the present invention has substantial, if not exclusive, utility. High rise structures have, in the last several years, come to life and dominate the urban landscape. As buildable land becomes more and more scarce, architects and builders have concentrated on structures which become more and more vertical. Moreover, since structures have in recent years become effectively sealed against the incursion of environmental elements and have compensated for the unavailability of fresh outdoor air by adding huge air conditioning apparatus, outside air is now brought in and filtered, heated and or cooled, as needed, for the comfort of the tenants.

The events of Sep. 11, 2001, have taught Americans that while use of conditioned air is in most instances efficient, in an emergency it poses new and difficult problems. It is in this environment that the present invention offers a solution to those people who might find themselves trapped several stories above mother Earth as a result of some incident which might make elevators, and even stair wells, hazardous, if not totally inaccessible.

In 2010, Edward Horn was awarded U.S. Pat. No. 7,766,124 for a high-rise evacuation system. That patent addressed the evacuation system which was intended to provide evacuation access to building occupants externally of the structure itself. As will become evident from a reading of the following, the present invention addresses an evacuation system which is located internally of the structure itself.

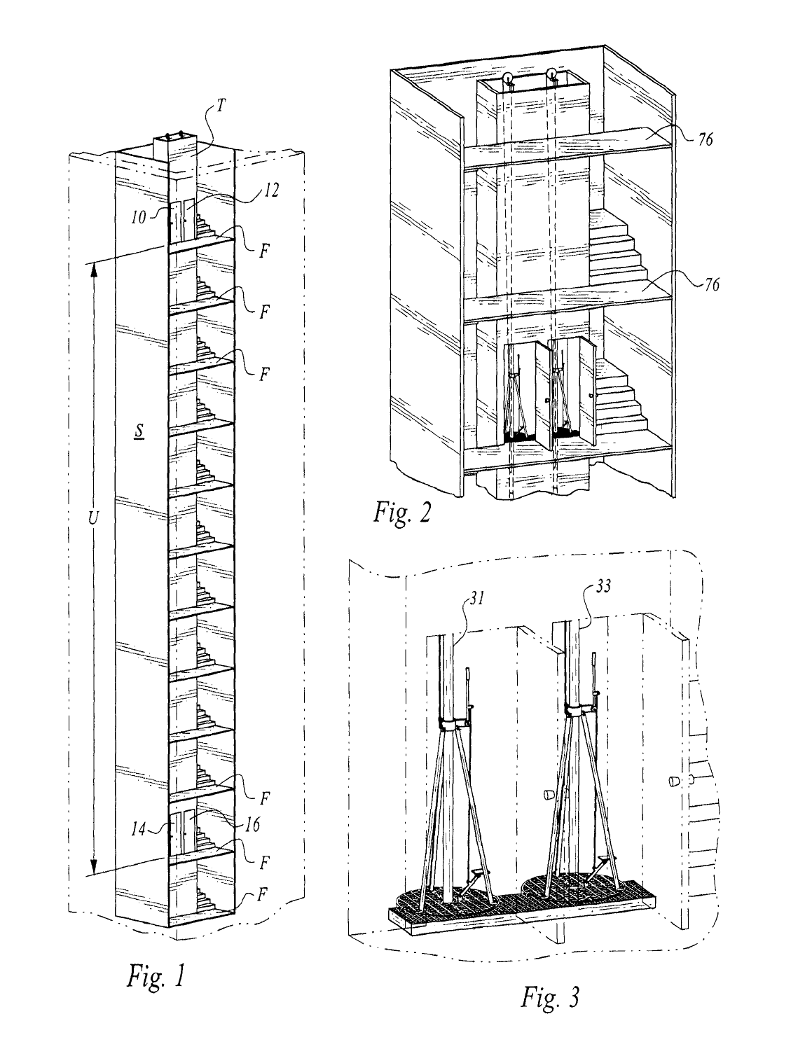

With the foregoing as background, reference is now made to the drawings, and initially to FIG. 1, wherein a portion of a typical high-rise stairwell S is depicted. Within the cavity which defines the stairwell S is an element of the system of the present invention, namely a fire inhibiting enclosure in the nature of an evacuation shaft or tube T. The shaft T is depicted as located adjacent to the stairs in the stairwell, and the evacuation tube T may be located at any place where it is accessible and convenient to occupants of all of the various floors F of the high-rise structure (not shown), as an important element of the system.

The evacuation shaft T, as shown, has a rectangular cross section on a vertical axis, although the shape is not really functionally important. It will be noted that the tube is made of fireproof material, and it has, e.g., doors 20 and 22 at its upper end and doors 24 and 26 at its lower extremity. In the present mode, 10 floors constitute a very functional unit U, the significance of which will become quickly apparent. A greater or lesser number of floors may be used at the election of the designer. An advantage of the ten floor segmented system is that people are moving down in every unit of the building simultaneously. On a 100-story high building, although there are only three people on each carriage, there are ten evacuators, so there are 30 people moving down at all times. With an estimated travel time of two minutes per trip, including loading time and transfer time, that is 900 people per hour.

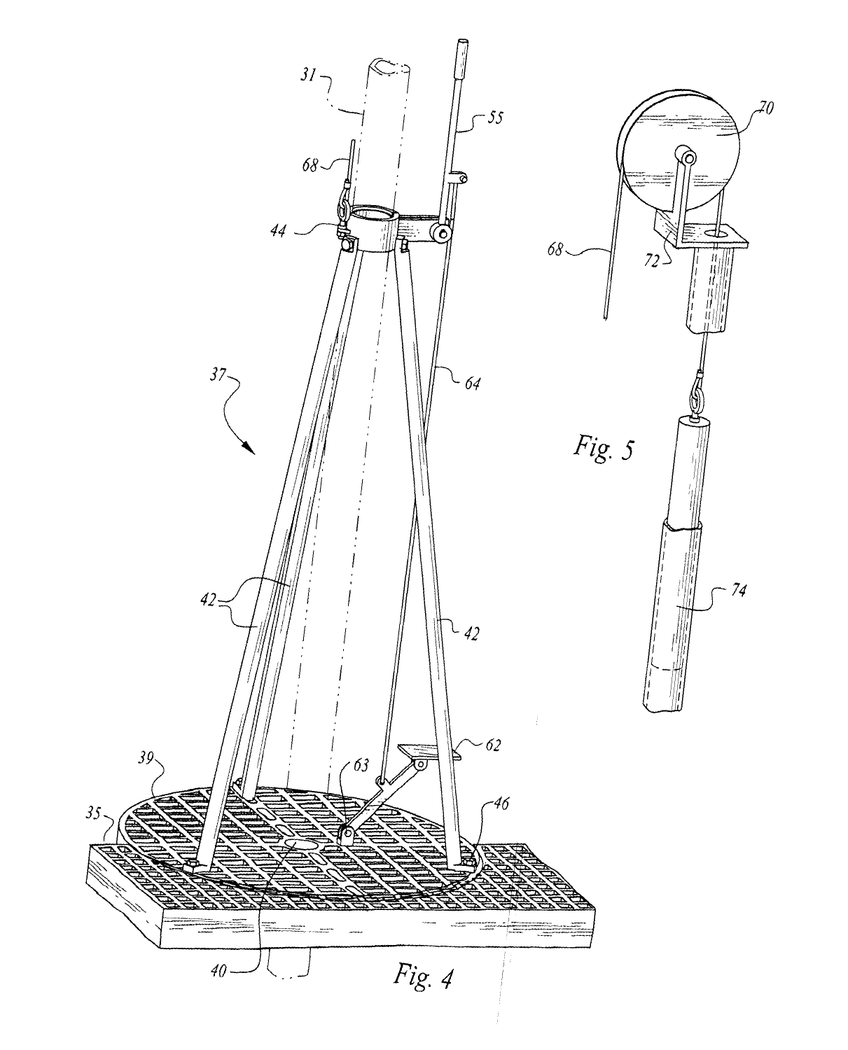

In keeping with the objectives of the present invention, embodied within the tube T is a MECHANICAL operating transport system. In many emergency situations, electrical power to the structure may be inoperative. The transport system of the present invention is, therefore, entirely gravitational mechanical in order that it need not rely on electrical power in its operation. The transport system is supported in the tube T and, in the order to optimize efficiency, includes a pair of parallel tubular guidance structures 31 and 33, best seen in FIGS. 3 and 4. Clearly, the number of tracks may vary as circumstances dictate. The transport system is built around the tubular structures, such as tracks 31 and 33, which are secured in any suitable manner to a base plate 35, providing both guidance and support, as will become apparent. While the use of a tubular structure is quite convenient, other shapes may be used and are within the contemplation of the invention.

Each track 31, 33 is fitted with a transporter, or evacuator, 37, illustrated in some detail in FIG. 4. A platform, or extension, 35 is provided, level with each floor F within the evacuation tube T and has an opening 36, which is of sufficient size to accommodate passage of a fully loaded evacuator 37. Each evacuator 37 is comprised of a base member, or platform, 39 which, in the illustrated case, is shown as circular, although other shapes may be suitable. The base member 37 is of sufficient size as to receive up to three individuals thereon for transportation to safety.

The base member 39 has a centrally positioned opening 40, of sufficient size to receive a track, such as 31 or 33, and struts 42 are affixed to, and extend upwardly from, the platform to a collar 44. The lower extremity of each strut 42 is secured to the platform 39 by means of a suitable fastener 46. Each strut 42 is rigid, in accordance with the invention, in order that a passenger situate on the base plate 39 will have a feeling of security as the evacuator moves downward to safety.

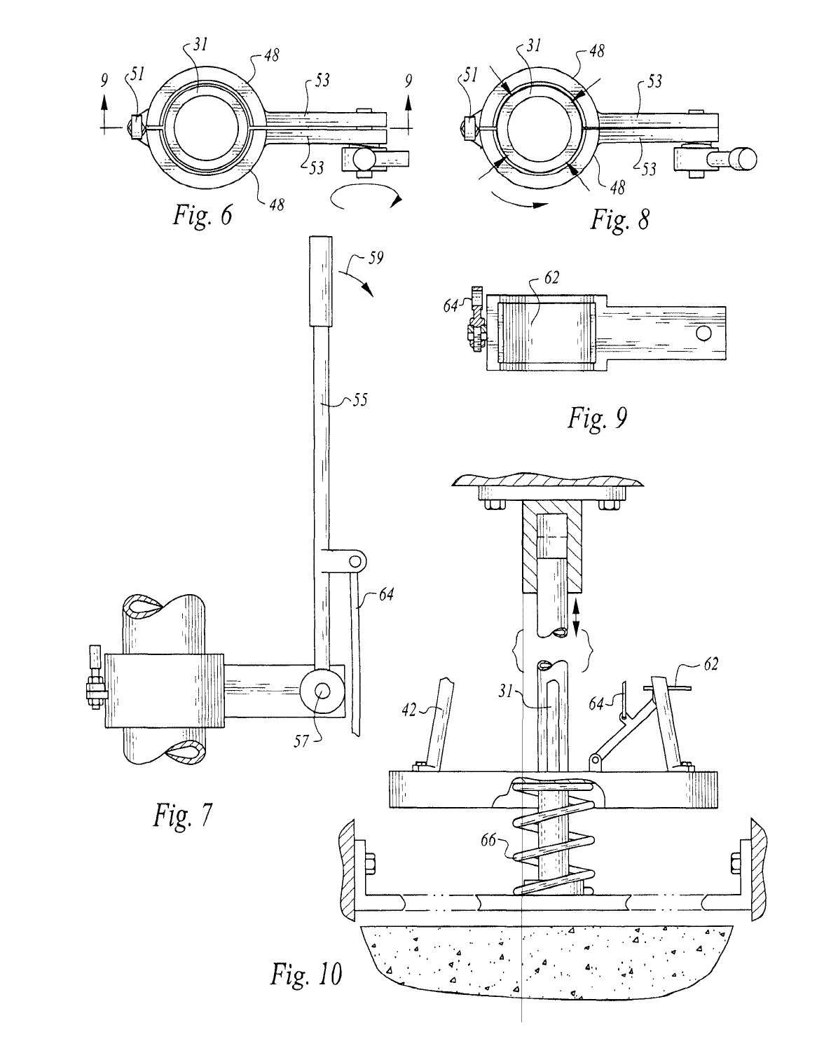

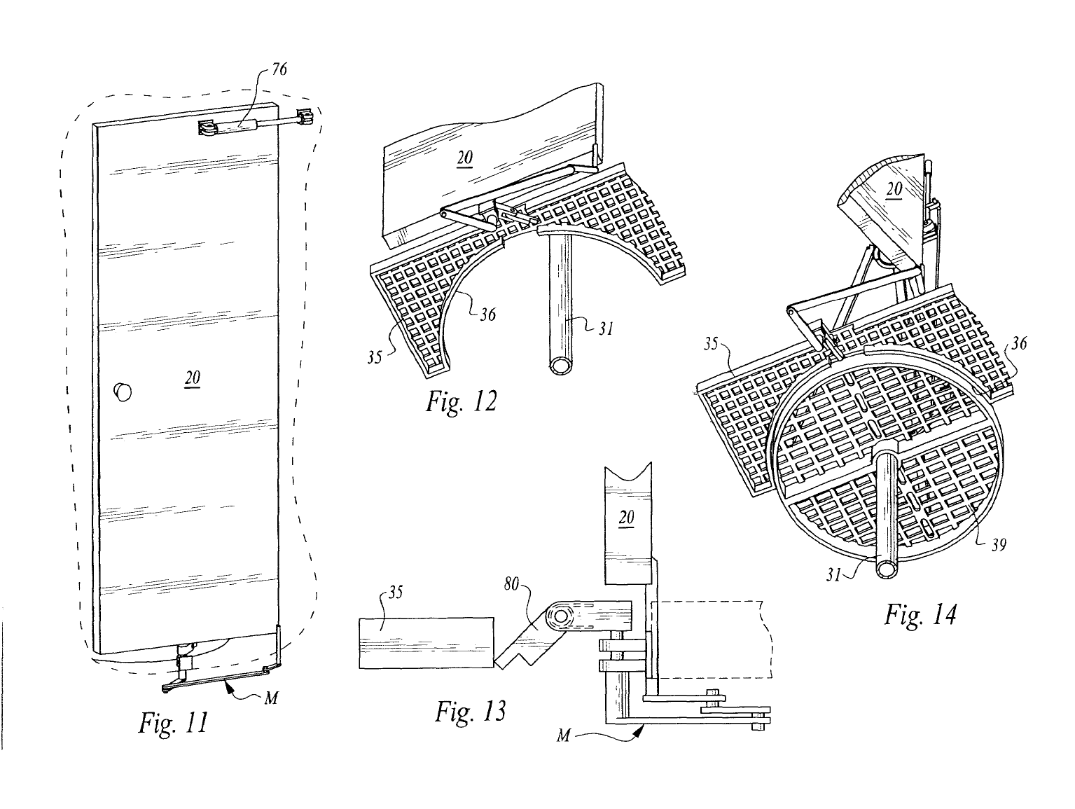

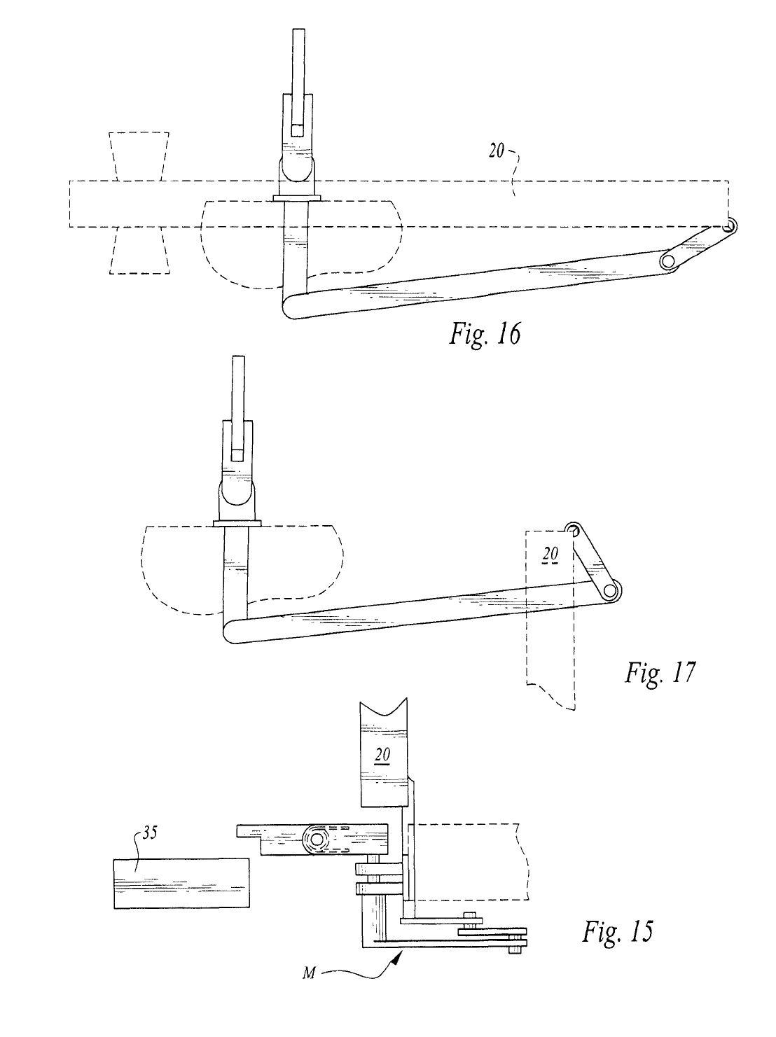

Moving to FIGS. 6 through 8, the purpose and function of the collar 44 as a brake will become apparent. Referring to FIGS. 6 and 8, the collar has a pair of clamping halves 48 held together by a suitable hinging fastener 51. The collar halves 48 circumscribe the track, e.g. 31, the collar halves 48 being capable of achieving limited movement transverse to the track so as to selectively grip it, thereby clamping the collar about the track 31, halting movement of the evacuator with sufficient grip so as to halt the evacuator fully loaded.

As an additional safety feature, in accordance with the invention, a foot pedal 62 is connected to the base plate 39 and is movable in a vertical plane about the clevis fastener 63 and, further, is mechanically connected to the handle 55 by rod 64. In each grouping of passengers, one of those passengers will be referred to as the designated operator, who shall be responsible for activating and braking the evacuator. If a passenger has difficulty in securing their safety belt, the designated operator can step on the floor brake pedal 62, thereby freeing both hands to help the passenger. Since the foot pedal and the handle are interconnected, either one may be used to stop the evacuator at the desired position, while, for example, passengers are being loaded onto it.

It will also be appreciated that the evacuator, when carrying passengers, tends to be heavier than usual. In order, therefore, to soften the landing, a damping spring 66, attached to the floor F, is provided, so that at the bottom of its travel the evacuator will be slowed by the spring more gently than would otherwise be the case.

It is self-evident that the evacuator must handle, in an emergency, more than three passengers sequentially. It is necessary, therefore, for the evacuator to return to an upper floor of a unit expeditiously in order to pick up and evacuate additional groups of three occupiers of the structure on that floor. A recovery system for mechanically returning the evacuator to the next floor for picking up passengers is within the contemplation of the invention and is not, therefore, illustrated in any particular form or detail. An example of an operative recovery system is shown in Horn FIGS. 5 and 6, and in the Horn specification, beginning in column 5 of the specification of the previously referenced Horn patent. Any other suitable gravitational system will, of course, be satisfactory.

In order to accomplish the next cycle, when the evacuator has unloaded its first group of evacuees, the door on the floor upon which the evacuees were unloaded will remain open until the last person on that floor has boarded the evacuator, at which time the door closer 76 will close the door on that floor. This may be accomplished by the use of a counterweight system such as in Horn '124, and, to do so mechanically, a cable 68, supported on a pulley 70 [FIG. 5], is used. The pulley is mounted to a bracket 72 engaged to the collar 44. A suitable weight 74 (which is suitably heavier than the evacuator) is movable within the track 31 so that when the evacuator 37 is devoid of the passengers, the weight 74 will move the evacuator upwardly until it detects waiting evacuees, at which time it stops at that particular floor. Where the base of a particular unit is not on a safe floor, the debarking evacuees move to the next available unit and are transported downwardly in that unit, and any subsequent units, until safe.

evacuees signal their position at a door on a given floor by opening that door. Once the door is opened, a signal arm 80 will extend into the path of the evacuator, causing it to stop at that floor. With the evacuator stopped and the door open, three evacuees, one of which will set the brake, then step onto the platform 39, and, when the door closes, the arm 80 is retracted and the evacuator descends to the lowest floor in the unit, e.g., 30 where it unloads its evacuees. The foregoing sequence is repeated until such time as all of the evacuees have been transported to a safe location. It will also be understood that when the evacuator initially moves down, signal arms extended by virtue of open doors are hinged so as to collapse downwardly to allow the evacuator to pass.

In accordance with the invention, each unit of the system will cover approximately 10 floors. At the base floor of each unit, with the exception of the arrival at the lowest floor, there will be a companion evacuator waiting for its arrival in order that passengers may transfer to the next unit and descend, once again, to the floor of that unit. Thus, when the evacuator, e.g., arrives at floor 30, there is no door to open because it and the waiting companion evacuator are already inside the enclosure. Since the evacuator floor and the transfer platform are then at the same level, passengers merely step over onto the transfer platform and onto the floor of the waiting companion unit.

As is now clear, a second system exists about track 33. Where it is structurally and otherwise prudent to do so, a longer unit may exist and would be designated as an express unit.

By way of example, assume a 40-story structure. In order to achieve the objectives of the present invention, there would be four units assembled within the structure, each unit covering ten floors thereof. Each unit would include a shaft and an evacuator system in each shaft. In the event of an emergency, say on floor 30, the evacuator on 40 would become involved because the people between 31 and 40 are at risk as a result of the damage at floor 30. When the evacuator is at the bottom floor of a 10-floor segment, there is no need to pull the brake handle because the evacuator will be sitting on the bumper spring at the bottom.

Occupants would move immediately to their evacuator system, open the door, and three at a time would get on the base member 39 after first activating the braking system by pulling the handle 55. Once the evacuees are loaded, the handle is released slowly and the evacuator moves to its lower level, which would be on floor 30. The occupants would immediately pull the handle to secure the evacuator and exit through the door and move to the unit between the floors 30 to 20. The process would continue until all have been evacuated.

The unit operating between floors 31 to 40, hangs at floor 40 and after the designated operator sets the hand brake, takes on three passengers, it goes down to floor 30, where the evacuees exit the unit. Then, with all doors open, the evacuator can only get to floor 31, where it is stopped by the arm protruding into the evacuation tube. The carriage will then go back up to floor 31, take on three more people and go back down to 30. This will continue until all passengers/evacuees on floor 31 are discharged to safety. Then the carriage will go back to floor 32, where it is stopped by the arm extending into the tube, and the process continues until everyone is off floor 32.

While those skilled in the art will, upon reading this detailed description, perceive alternative structures to those specifically designated, it will be appreciated that such additional and alternative structures are within the contemplation of the invention, as set forth in the following claims:

1. A system for the evacuation of occupants of a high rise structure in an emergency, comprising, in combination:
a series of units, each unit spanning several floors of the high rise structure;
each said unit containing at least one evacuation tube;
said evacuation tube having at least one centrally positioned track longitudinally extending from top to bottom of said evacuator tube;
an evacuator, said evacuator including a platform of a size sufficient to accommodate at least three occupants, said evacuator including a collar positioned about said track and rigidly affixed to said platform, said collar being expandable and contractible about said track, said evacuator being slidably engaged with said track;
a braking system, said braking system being mechanical in structure and capable of selectively engaging and stopping said evacuator when pressed about said track;
said evacuator tube having selective access to said evacuator in order that occupants may move onto said evacuator in turn.

2. The system of claim 1, wherein a recovery system is provided as part of said evacuator, said recovery system adapted to move said platform upwardly when occupants have vacated the evacuator.

3. The system of claim 1, wherein said track is of tubular construction.

4. The system of claim 1, wherein said evacuator tube being of fire proof construction.

5. The system of claim 1, wherein a door in said evacuator tube limits access from a given floor in a unit to the evacuator within said evacuation tube.

6. The system of claim 1, wherein said collar is selectively actuated to provide braking, said collar having a foot pedal attached, said foot pedal being activated by an occupant to hold said evacuator in position for access by occupants.

7. The system of claim 6, wherein said collar being provided with a handle, said handle being attached to said foot pedal, and whereas movement of said handle actuates said braking system.

8. Constructed within a high rise structure, a system for evacuation of occupants of the structure in an emergency, comprising:
an evacuation system; said evacuation system comprising at least one unit; an evacuation tube, said evacuation tube spanning the structure from its top floor to its bottom floor;
an evacuator, said evacuator being movable from the top floor of each said unit to its lowest floor; said evacuator including a platform of a size sufficient to accommodate at least three occupants, said evacuator including a collar positioned about said track and rigidly affixed to said platform, said collar being expandable and contractible about said track;
each said floor having a door in said evacuation tube, said door providing access to and from said evacuation tube.

9. The system for evacuation of claim 8, having a signal arm, said signal arm being extensible into said evacuator tube in the path of said evacuator, said signal arm causing said evacuator to stop at said signal arm to position said evacuator for receipt of occupants from the adjacent floor.

10. The system of claim 2, wherein a door in said evacuator tube limits access from a given floor in a unit to the evacuator within said evacuator tube.

11. The system for evacuation of claim 8, wherein a recovery system is provided as part of said evacuator, said recovery system adapted to move said platform upwardly when occupants have vacated the evacuator.

12. The system for evacuation of claim 8, wherein said collar is selectively actuated to provide braking, said collar having a foot pedal attached, said foot pedal being activated by an occupant to hold said evacuator in position for access by occupants.
